(19) United States
(12) Patent Application Publication
(10) Pub. No.: US 2026/0259557 A1
(43) Pub. Date: Sep. 3, 2026

(54) SHAPE RESTORATION DEVICE AND COMPUTER-READABLE STORAGE MEDIUM

(71) Applicant: FANUC CORPORATION, Yamanashi (JP)

(72) Inventors: Wei ZHAO, Yamanashi (JP); Nobuaki AIZAWA, Yamanashi (JP); Shinichi OZEKI, Yamanashi (JP)

(21) Appl. No.: 19/489,265

(22) PCT Filed: Jul. 25, 2023
(86) PCT No.: PCT/JP2023/027114

§ 371 Date: Dec. 2, 2025

(51) Int. Cl. G05B 19/418

(52) U.S. Cl. CPC G05B 19/41885; G05B 19/4184

(57) ABSTRACT

This shape restoration device comprises: an acquisition unit that acquires processing information indicating a condition when a processing surface is processed by a tool, trajectory information indicating a trajectory when the processing surface is processed by the tool, and processing surface data indicating the state of the processing surface; a filter generation unit that generates a filter on the basis of the processing information; an adjustment unit that, on the basis of the trajectory information, executes adjustment of the direction of filter processing using the filter for the processing surface data or adjustment of the coefficient of the filter; and a filter processing unit that executes filter processing on the basis of an adjustment result by the adjustment unit.

### RELATED APPLICATIONS

The present application is a National Phase of International Application No. PCT/JP2023/027114 filed Jul. 25, 2023.

### TECHNICAL FIELD

This disclosure relates generally to a shape restoration device and a computer-readable storage medium.

### BACKGROUND ART

Conventionally, data indicating irregularity of a machined surface of a workpiece is acquired using a machining program. For example, when a machining simulation is performed using the machining program, machined surface data indicating irregularity of the machined surface can be obtained (for example, Patent Document 1).

### CITATION LIST

### Patent Document

Patent Document 1: JP 2017-156170 A

### BRIEF DESCRIPTION OF DRAWINGS

FIG. 1 is a block diagram illustrating an example of a hardware configuration of a shape restoration device;

FIG. 2 is a block diagram illustrating an example of a function of the shape restoration device;

FIG. 3A is a diagram illustrating an example of a machined surface indicated by machined surface data generated by a simulator;

FIG. 3B is an enlarged partial view of the machined surface;

FIG. 4 is a diagram illustrating an example of machined surface data converted into two-dimensional data;

FIG. 5 is a diagram illustrating an example of a one-dimensional filter generated by a filter generator;

FIG. 6 is a diagram for describing a direction of a filtering process;

FIG. 7 is a diagram illustrating an example of a machined surface on which a shape component is extracted;

FIG. 8 is an example of a two-dimensional filter generated by the filter generator;

FIG. 9 is an example of a filter whose coefficients are adjusted by an adjuster;

FIG. 10 is a flowchart illustrating an example of processing performed by the shape restoration device;

FIG. 11 is a block diagram illustrating an example of functions of the shape restoration device;

FIG. 12 is a diagram for describing uniform sampling;

FIG. 13 is a diagram for describing random sampling;

FIG. 14A is a diagram illustrating an example of a machined surface undergoing a filtering process and a correction surface;

FIG. 14B is a diagram illustrating an example of the machined surface undergoing the filtering process and the correction surface;

FIG. 15A is a diagram for describing setting of a distance between the machined surface and the correction surface;

FIG. 15B is an example of a correction surface generated by a correction surface generator;

FIG. 16 is a diagram illustrating an example of the machined surface; and

FIG. 17 is a flowchart illustrating an example of processing executed by the shape restoration device.

### DETAILED DESCRIPTION

The machined surface data generated by the machining simulation unwillingly includes information indicating a surface property such as cutting marks of a tool. In other words, in the machining simulation, it is impossible to acquire machined surface data indicating a design shape of a workpiece that does not include cutting marks and so on. For this reason, there is demand for technology that can acquire machined surface data indicating a design shape of a workpiece from machined surface data that includes information indicating a surface property such as cutting marks.

A shape restoration device of the disclosure includes an acquirer configured to acquire machining information indicating a condition when a machined surface is machined by a tool, path information indicating a path when the machined surface is machined by the tool, and machined surface data indicating a state of the machined surface, a filter generator configured to generate a filter for extracting a shape component of the machined surface from the machined surface data based on the machining information acquired by the acquirer, an adjuster configured to perform, based on an adjustment result by the adjuster, an adjustment of a direction of a filtering process using the filter on the machined surface data or an adjustment of coefficients of the filter, and a filter processor configured to execute the filtering process adjuster.

A computer-readable storage medium of the disclosure stores an instruction for causing a computer to acquire machining information indicating a condition when a machined surface is machined by a tool, path information indicating a path when the machined surface is machined by the tool, and machined surface data indicating a state of the machined surface, generate a filter for extracting a shape component of the machined surface from the machined surface data based on the acquired machining information, execute adjustment of a direction of a filtering process using the filter on the machined surface data or adjustment of coefficients of the filter based on the path information, and execute the filtering process based on an adjustment result.

Hereinafter, a shape restoration device and a computer-readable storage medium according to an embodiment of the disclosure will be described with reference to the drawings. Note that, in the following description, components having the same or similar functions are denoted by the same reference numerals. In addition, duplicate descriptions of those components are omitted in some cases.

In this application, “based on XX” means “based on at least XX” and includes a case of being based on another element in addition to XX. Furthermore, “based on XX” is not limited to a case where XX is directly used, and includes a case of being based on an element obtained by performing calculation or machining on XX. “XX” is any element (for example, any information).

The shape restoration device is a device for restoring a shape of a machined surface from machined surface data. In other words, the shape restoration device is a device for extracting a shape component from the machined surface data and generating new machined surface data.

The machined surface data is data that indicates a state of the machined surface. The state of the machined surface is, for example, a form of irregularity of the machined surface.

The machined surface data indicating the state of the machined surface is generated, for example, by a machining simulation using a machining program. The machining simulation is, for example, a simulation of a cutting process by a machining device.

The shape restoration device is mounted in, for example, a numerical controller, a PC (Personal Computer), a server, or a tablet terminal.

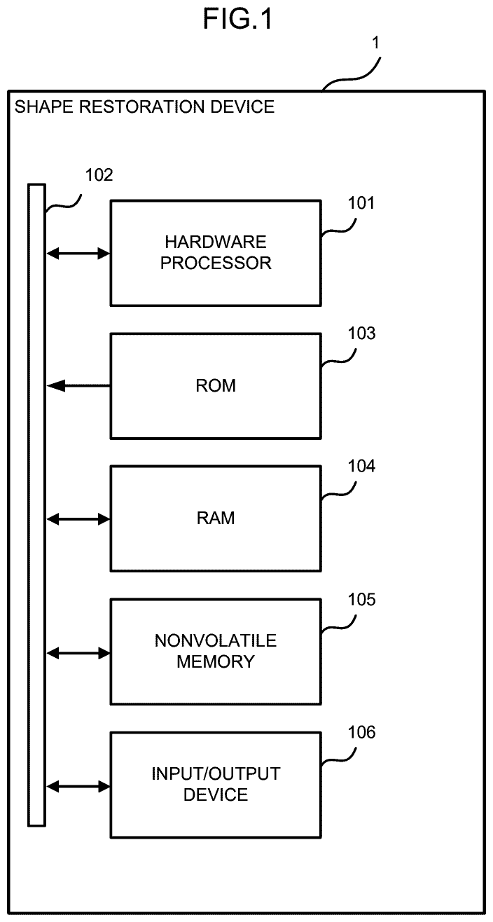

FIG. 1 is a block diagram illustrating an example of a hardware configuration of the shape restoration device. The shape restoration device 1 includes, for example, a hardware processor 101, a bus 102, a ROM (Read Only Memory) 103, a RAM (Random Access Memory) 104, a nonvolatile memory 105, and an input/output device 106.

The hardware processor 101 is a processor for controlling the entire shape restoration device 1 using a system program. The hardware processor 101 reads the system program and the like stored in the ROM 103 via the bus 102. The hardware processor 101 is, for example, a CPU (Central Processor) or an electronic circuit.

The bus 102 is a communication path that connects each piece of hardware in the shape restoration device 1 to each other. Each piece of hardware in the shape restoration device 1 exchanges data via the bus 102.

The ROM 103 is a storage device that stores the system program, etc. The ROM 103 is a computer-readable storage medium.

The RAM 104 is a storage device for temporarily storing various data. The RAM 104 functions as a working area for the hardware processor 101 to process various data.

The nonvolatile memory 105 is a storage device for retaining data even when the shape restoration device 1 is turned off. The nonvolatile memory 105 stores, for example, the machined surface data. The nonvolatile memory 105 is a computer-readable storage medium. The nonvolatile memory 105 is configured as, for example, a battery-backed memory or a solid state drive (SSD).

The input/output device 106 receives various data from, for example, the hardware processor 101, and causes a display to display the various data. In addition, the input/output device 106 receives input of the various data and then sends the various data to, for example, the hardware processor 101.

The input/output device 106 is, for example, a touch panel. When the input/output device 106 is a touch panel, the input/output device 106 is, for example, a capacitive touch panel. The touch panel is not limited to the capacitive touch panel, and may be another type of touch panel.

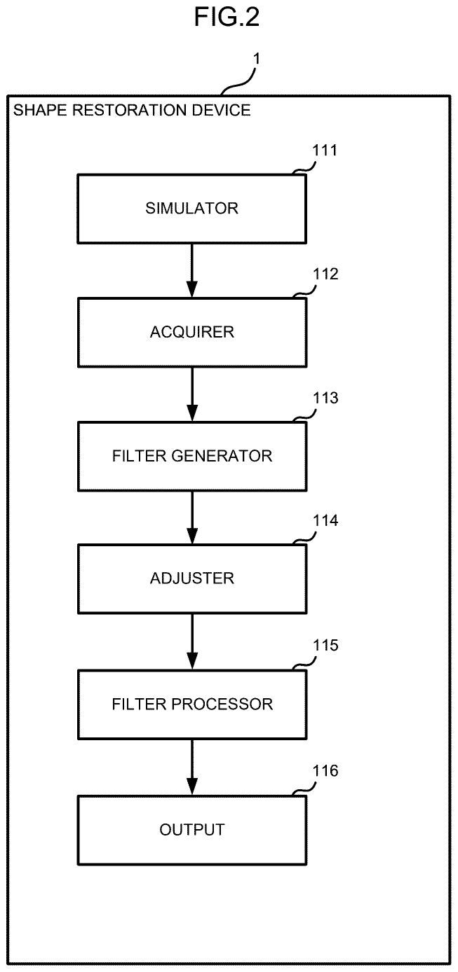

FIG. 2 is a block diagram illustrating an example of functions of the shape restoration device 1. The shape restoration device 1 includes a simulator 111, an acquirer 112, a filter generator 113, an adjuster 114, a filter processor 115, and an output 116. The simulator 111, the acquirer 112, the filter generator 113, the adjuster 114, the filter processor 115, and the output 116 are actualized, for example, by the hardware processor 101 performing arithmetic processing using the system program stored in the ROM 103 and various programs and data stored in the nonvolatile memory 105.

The simulator 111 executes the machining simulation to generate machined surface data. The machining simulation is a process of generating machined surface data based on a virtual model of a machining device, a machining program, and machining information. For example, the simulator 111 generates machined surface data based on a virtual model, a machining program, and machining information stored in a storage unit (not shown).

The virtual model includes, for example, a model of a structure included in the machining device and a model of a workpiece. The model of the structure is generated based on information such as a shape, a weight, hardness, and a material of the structure. The model of the workpiece is generated based on information such as a shape, a weight, hardness, and a material of the workpiece.

The machining information is information indicating a condition when the machined surface is machined by a tool. The machining information includes at least one of information indicating a radius of the tool, information indicating a shape of the tool, information indicating the number of teeth of the tool, information indicating maximum acceleration of a control axis, information indicating an acceleration time of the control axis, information indicating a time constant of a servo mechanism, information indicating gain of the servo mechanism, information indicating a pick feed, or information indicating a point sequence distance.

The information indicating the shape of the tool includes information indicating a type of tool. For example, the type of tool includes a ball end mill and a square end mill.

The information indicating the gain of the servo mechanism includes information indicating at least one of speed gain, current gain, position gain, or feedforward setting of the servo mechanism. Note that the feedforward setting is setting for predicting a delay in an operation of the servo mechanism and commanding the delay in advance.

The pick feed is an interval of a tool path designated in CAM (Computer Aided Manufacturing). For example, when a first path of the tool and a second path adjacent to the first path are parallel, the pick feed is a distance between the first path and the second path. The point sequence distance is a distance between a plurality of points for designating the tool path.

The machined surface data is, for example, three-dimensional data indicating a height of the machined surface. That is, the machined surface data is three-dimensional data indicating a form of irregularity of the machined surface. The machined surface data may be two-dimensional data indicating the height of the machined surface. The two-dimensional data indicating the height of the machined surface is also referred to as a height map.

The machined surface data generated by the simulator 111 includes a plurality of components. The plurality of components is a high-frequency component and a low-frequency component included in a waveform when the irregularity of the machined surface is regarded as the waveform.

The high-frequency component is a surface property component. The surface property component is, for example, a component that indicates cutting marks. The surface property component is also referred to as a roughness component.

The low-frequency component is a shape component. The shape component is a component that indicates a design shape of the workpiece.

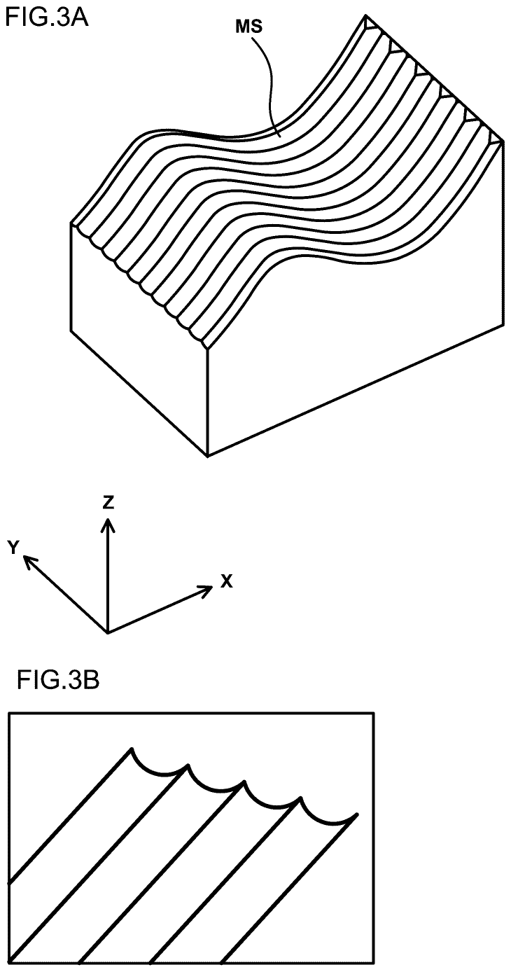

FIG. 3A is a diagram illustrating an example of a machined surface indicated by the machined surface data generated by the simulator 111. FIG. 3B is an enlarged partial view of the machined surface.

In the example illustrated in FIG. 3A, the machined surface MS has a shape having a large convex portion and a large concave portion along an X-axis. Irregularity along the X-axis is a shape component.

Furthermore, the machined surface MS has a plurality of arc-shaped grooves that are continuous along a Y-axis (FIG. 3B). When the plurality of grooves that is continuous along the Y-axis is regarded as a waveform, a frequency of this waveform is higher than a frequency of the irregularity described above. The plurality of grooves formed along the Y-axis is surface property components. In addition, the plurality of grooves is cutting marks formed by the tool. Here, the description returns to that of FIG. 2.

The acquirer 112 acquires machining information that indicates a condition when the machined surface MS is machined by the tool, path information that indicates a path when the machined surface MS is machined by the tool, and machined surface data that indicates a state of the machined surface MS.

The acquirer 112 acquires, for example, machining information from a machining information storage unit (not illustrated). Furthermore, the acquirer 112 acquires the machined surface data generated by the simulator 111.

The acquirer 112 acquires, for example, path information from the machined surface data. In the examples illustrated in FIG. 3A and FIG. 3B, a plurality of arc-shaped grooves is formed parallel to an XZ plane. In this case, the acquirer 112 acquires, for example, a direction along the X-axis as path information indicating the tool path.

The acquirer 112 may acquire path information indicating the path of the tool based on the machining program. That is, the acquirer 112 may analyze the machining program to acquire the path information indicating the path of the tool.

The machined surface data acquired by the acquirer 112 is converted into two-dimensional data.

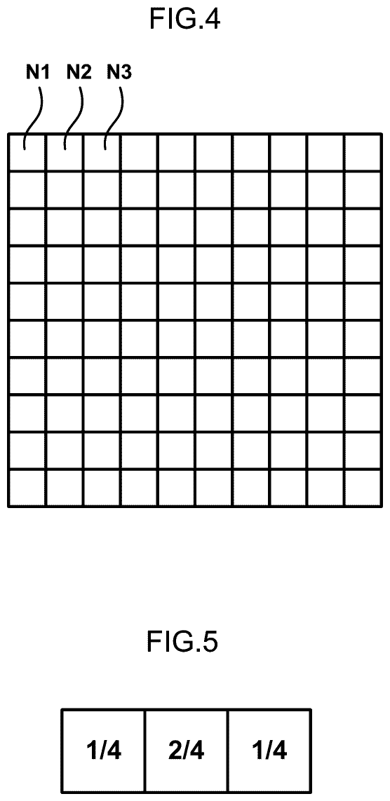

FIG. 4 is a diagram illustrating an example of the machined surface data converted into the two-dimensional data. The two-dimensional data is data in which numerical values N1, N2, and N3 indicating heights of the machined surface are associated with respective regions divided in a grid shape and recorded. Although illustration is omitted, numerical values indicating heights of the machined surface are similarly associated and recorded for the other regions.

The two-dimensional data is generated so that the tool path is along a row or a column of the two-dimensional data. For example, in a certain row of the two-dimensional data, numerical values indicating height of one groove formed along the X-axis are recorded in order. In addition, in another row of the two-dimensional data, numerical values indicating height of another groove formed along the X-axis are recorded. By generating the tool path along a row or a column of the two-dimensional data, a filtering process described below can be effectively performed.

The filter generator 113 generates a filter for extracting a shape component of the machined surface MS from the machined surface data based on the machining information acquired by the acquirer 112.

The filter is at least one of a low-pass filter, a high-pass filter, a band-pass filter, or a band-stop filter. The filter is, for example, a Gaussian filter or a Laplacian filter. Further, the filter is a one-dimensional filter or a two-dimensional filter.

The filter generator 113 sets a threshold value of the filter based on, for example, a pick feed indicated by the tool path in the machined surface MS. The threshold value set in the filter is a threshold value for extracting a specific component.

When the threshold value of the filter is set based on the pick feed, the threshold value of the filter is a threshold value for separating the surface property component of the machined surface MS. The filter for separating the surface property component and extracting the shape component is the low-pass filter. Note that the threshold value is also referred to as a cutoff value or a nesting index.

FIG. 5 is a diagram illustrating an example of the one-dimensional filter generated by the filter generator 113. A kernel width of the one-dimensional filter is, for example, 1×3. A filter coefficient is determined according to the threshold value.

The adjuster 114 adjusts a direction of the filtering process using the filter for the machined surface data based on the path information.

The filtering process is a process of extracting a specific component from machined surface data. For example, the filtering process is a process of extracting a shape component by separating a surface property component from machined surface data including the surface property component and the shape component.

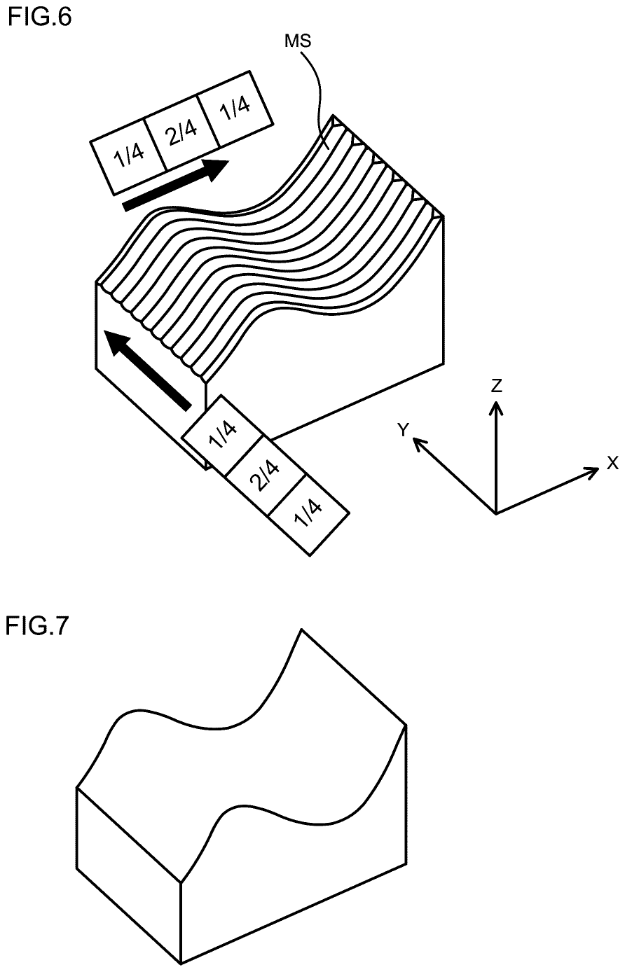

FIG. 6 is a diagram for describing the direction of the filtering process. The direction of the filtering process is, for example, a direction along the tool path or a direction perpendicular to the tool path. In an example illustrated in FIG. 6, the direction along the tool path is a direction along the X-axis. In the example illustrated in FIG. 6, the direction perpendicular to the tool path is a direction along the Y-axis.

Adjusting the direction of the filtering process is to determine the direction of the filtering process for extracting a specific component from the machined surface data. The specific component is, for example, the shape component.

In the machined surface data illustrated in FIG. 6, the surface property component does not appear in the direction along the tool path. In this case, even when the filtering process is performed in the direction along the tool path, the surface property component cannot be separated from the machined surface data.

On the other hand, the surface property component appears in the direction perpendicular to the tool path. In this case, by performing the filtering process in the direction perpendicular to the tool path, the surface property component can be separated from the machined surface data and the shape component can be extracted. Therefore, the adjuster 114 determines the direction of the filtering process to be the direction perpendicular to the tool path.

FIG. 7 is a diagram illustrating an example of a machined surface on which the surface property component is separated and the shape component is extracted. The cutting marks are removed from the machined surface illustrated in FIG. 7. That is, the adjuster 114 determines the direction of the filtering process to be the direction perpendicular to the tool path, thereby acquiring machined surface data that represents only the shape component.

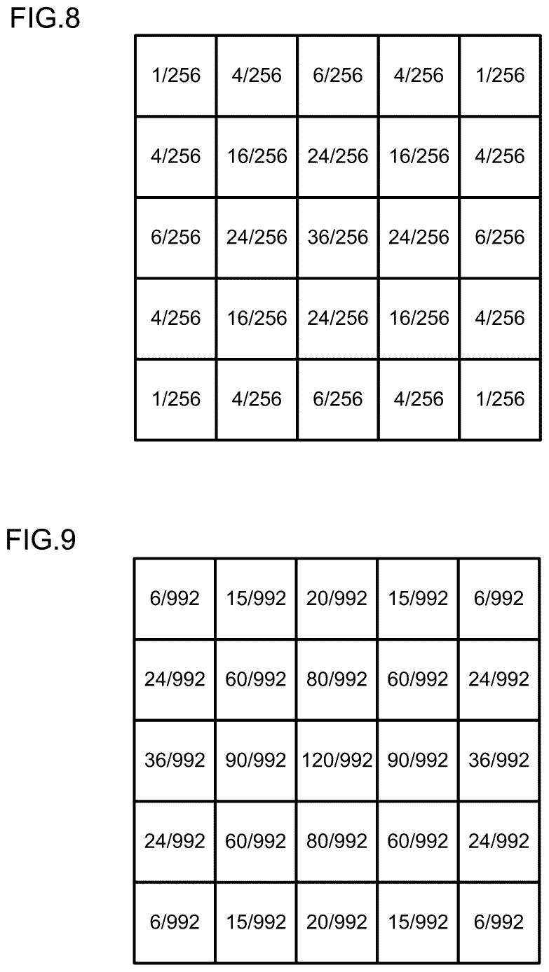

FIG. 8 is an example of the two-dimensional filter generated by the filter generator 113. A kernel width of the two-dimensional filter is, for example, 5×5. A filter coefficient is determined according to a threshold value.

Coefficients in a first row of the filter illustrated in FIG. 8 are 1/256, 4/256, 6/256, 4/256, and 1/256. That is, the ratio of the respective coefficients is 1:4:6:4:1. Ratios of respective coefficients in the other rows and columns are similar. In other words, in the filter illustrated in FIG. 8, strength in a direction along the rows is the same as strength in a direction along the columns. Strength is an index that indicates how accurately a particular component can be extracted.

The adjuster 114 performs an adjustment of filter coefficients based on the path information.

FIG. 9 is an example of a filter, coefficients of which are adjusted by the adjuster 114. A ratio of coefficients arranged along a column of the filter is 1:4:6:4:1. On the other hand, a ratio of coefficients arranged along a row of the filter is 6:15:20:15:6. In other words, in the filter illustrated in FIG. 9, strength in a direction along the columns is higher than strength in a direction along the rows.

When the shape component of the machined surface illustrated in FIG. 3A is extracted, the adjuster 114 adjusts the filter coefficients so that strength in the direction perpendicular to the tool path becomes higher.

The filter processor 115 performs a filtering process based on an adjustment result by the adjuster 114. That is, the filter processor 115 performs a filtering process of the machined surface MS based on the direction of the filtering process adjusted by the adjuster 114.

When the filter is a one-dimensional filter, the adjuster 114 determines to perform the filtering process in the direction perpendicular to the tool path. Therefore, the filter processor 115 performs the filtering process in the direction perpendicular to the tool path.

In this way, the filter processor 115 restores the shape of the machined surface MS. In other words, the filter processor 115 separates the surface property component from the machined surface data to generate new machined surface data indicating the shape component. The new machined surface data is two-dimensional data generated by the filtering process, or three-dimensional data converted from the two-dimensional data.

When the filter is a two-dimensional filter, the adjuster 114 adjusts filter coefficients so that strength in the direction perpendicular to the tool path becomes high. Therefore, the filter processor 115 executes the filtering process using a filter the strength of which in the direction perpendicular to the tool path is increased. In this way, the filter processor 115 restores the shape of the machined surface MS. Here, the description returns to that of FIG. 2.

The output 116 outputs the newly generated machined surface data by separating the surface property component. The output 116 outputs the newly generated machined surface data to, for example, the input/output device 106. The input/output device 106 displays the new machined surface data on the display.

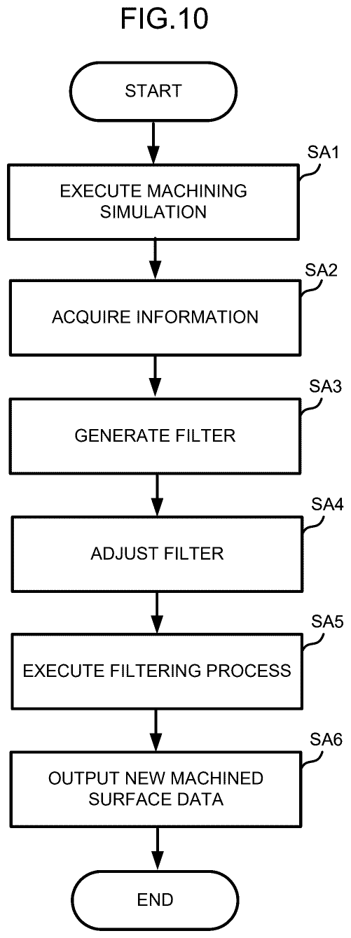

FIG. 10 is a flowchart illustrating an example of processing performed by the shape restoration device 1. In the shape restoration device 1, first, the simulator 111 executes the machining simulation (step SA1).

Next, the acquirer 112 acquires the machining information, the path information, and the machined surface data (step SA2). Next, the filter generator 113 generates a filter (step SA3).

Next, the adjuster 114 adjusts the direction of the filtering process or adjusts the filter coefficients (step SA4). Next, the filter processor 115 executes the filtering process (step SA5). Finally, the output 116 outputs the new machined surface data (step SA6), and the process ends.

In the above-mentioned embodiment, the machined surface data is generated by the simulator 111. However, the machined surface data may be inspection data acquired by an inspection device that inspects the state of the machined surface MS. In other words, the machined surface data may be data indicating the state of the machined surface MS actually machined by the machining device. In this case, the acquirer 112 may acquire the inspection data acquired by the inspection device.

In the above-mentioned embodiment, a description is given of an example in which the tool path is formed along one direction in the entire machined surface MS. However, the tool path may be different in each region of the machined surface MS. In this case, the shape restoration device 1 may execute the filtering process by generating a filter and adjusting the filter, for each region in which the tool path is directed in the same direction.

In the above-mentioned embodiment, a description is given of an example in which the surface property component is separated from the machined surface data and the shape component is extracted by the filtering process. However, when there is a defect such as a streak or a pattern on the machined surface indicated by the machined surface data, the defect cannot be removed in some cases. In this case, the shape restoration device 1 may correct the machined surface data undergoing the filtering process by the filter processor 115.

Note that the streak is a scratch formed on a machined surface deeper than a cutting mark. The streak is formed, for example, since a user makes an operational mistake in CAM, which causes a defect in the machining program. In addition, the pattern appears when the tool machines a curved surface and a path of the tool is formed by a plurality of minute line segments. In other words, the pattern may appear due to tolerance settings in CAM.

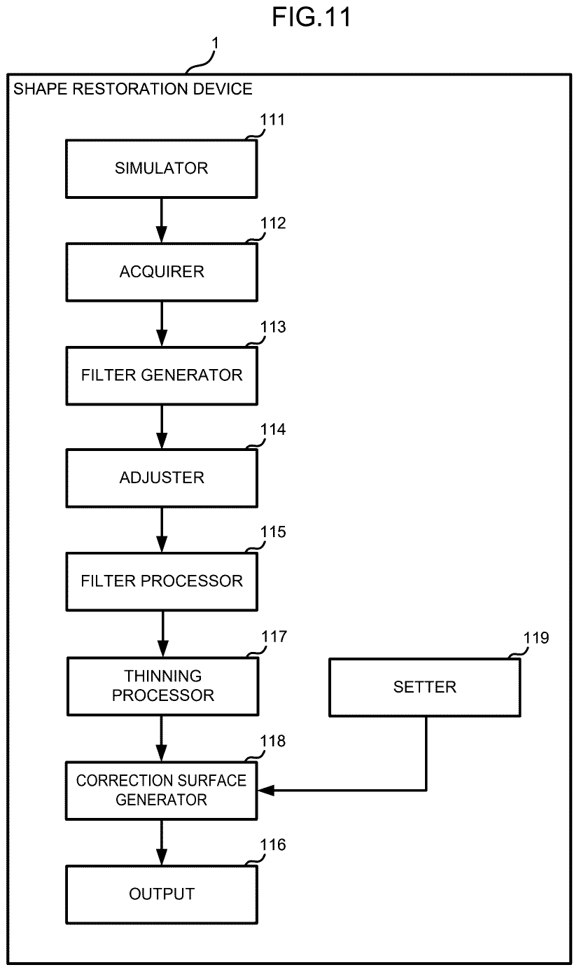

FIG. 11 is a block diagram illustrating an example of functions of the shape restoration device 1. The shape restoration device 1 illustrated in FIG. 11 includes a thinning processor 117, a correction surface generator 118, and a setter 119 in addition to the functions of the shape restoration device 1 illustrated in FIG. 2. The thinning processor 117, the correction surface generator 118, and the setter 119 are actualized, for example, by the hardware processor 101 performing arithmetic processing using the system program stored in the ROM 103 and the various programs and data stored in the nonvolatile memory 105.

The thinning processor 117 determines whether or not the machined surface data undergoing the filtering process needs to be corrected. In other words, the thinning processor 117 determines whether or not to perform a thinning process on the machined surface data undergoing the filtering process.

For example, the thinning processor 117 determines whether or not the machined surface data undergoing the filtering process has a defect. For example, when a streak of a predetermined depth or more is present on the machined surface indicated by the machined surface data undergoing the filtering process, the thinning processor 117 determines that thinning processing is necessary.

When determining that the thinning process is necessary, the thinning processor 117 performs the thinning process to thin out some data from the machined surface data undergoing the filtering process. The thinning processor 117 performs the thinning process by means of using, for example, at least one of uniform sampling, random sampling, or normal space sampling.

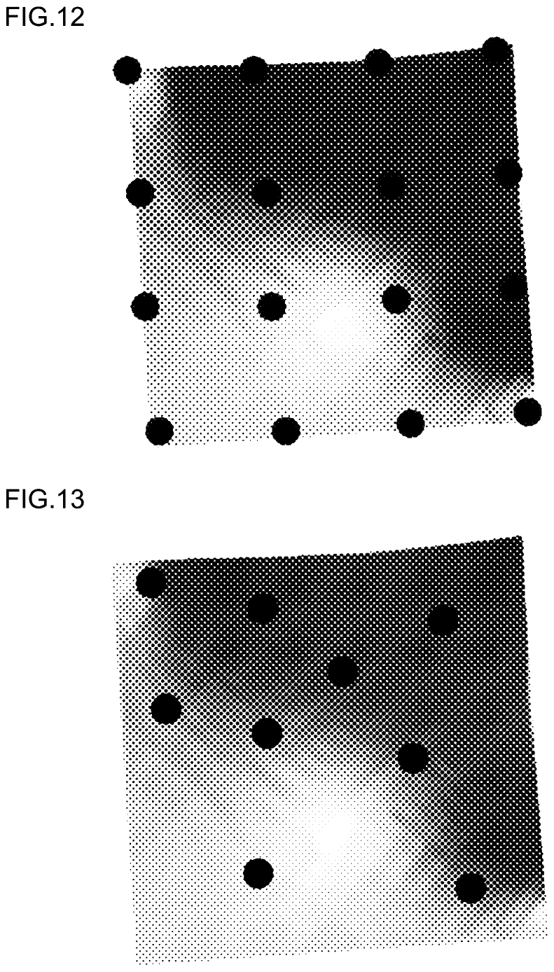

FIG. 12 is a diagram for describing uniform sampling. In uniform sampling, sampling is performed at predetermined intervals on the machined surface. In FIG. 12, positions of black circles are sampled positions. In other words, the thinning processor 117 thins out data at positions other than positions to be sampled.

FIG. 13 is a diagram for describing random sampling. In random sampling, sampling is randomly performed on the machined surface. In FIG. 13, positions of black circles are sampled positions. In other words, the thinning processor 117 thins out data at positions other than positions to be sampled.

In normal space sampling, data at positions where a direction of a normal to the machined surface significantly changes is sampled with emphasis. Therefore, in normal space sampling, for example, data at positions where the shape of the machined surface significantly changes is sampled with emphasis.

The correction surface generator 118 generates a correction surface obtained by correcting a machined surface from machined surface data where a piece of the data is thinned out by the thinning processor 117. Correction is to smooth out defects formed on the machined surface so that the defects are less noticeable.

The correction surface generator 118 generates a correction surface using at least one of a linear interpolation curved surface approximation, a cubic spline interpolation curved surface approximation, a nearest neighbor point interpolation curved surface approximation, or an interpolation approximation using a radial basis function.

The correction surface generator 118 generates a correction surface so that a difference between the machined surface undergoing the filtering process and the correction surface falls within a predetermined range.

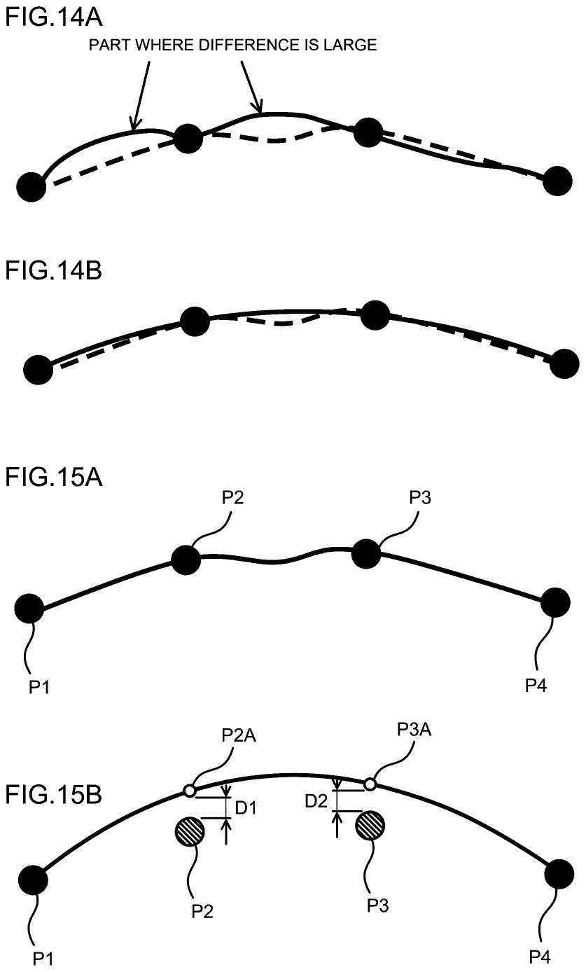

FIGS. 14A and 14B are diagrams illustrating examples of the machined surface undergoing the filtering process and the correction surface. A dotted line indicates the machined surface. A solid line indicates the correction surface.

In the example illustrated in FIG. 14A, there is a part where the difference between the machined surface and the correction surface is large. In other words, the difference between the machined surface and the correction surface does not fall within the predetermined range.

In the example illustrated in FIG. 14B, the difference between the machined surface and the correction surface is small overall. In other words, the difference between the machined surface and the correction surface is within the predetermined range.

When the difference between the generated correction surface and the machined surface is not within the predetermined range, the correction surface generator 118 may regenerate the correction surface so that the difference between the machined surface and the correction surface is within the predetermined range.

The shape restoration device 1 may be able to individually set distances between a plurality of positions included in the machined surface data undergoing the thinning process and a plurality of corresponding positions corresponding to a plurality of positions included in the correction surface, respectively. In other words, the user can set a degree to which the machined surface indicated by the machined surface data undergoing the filtering process is to be corrected. In this case, the shape restoration device 1 further includes the setter 119 that individually sets the distances between the plurality of positions included in the machined surface data undergoing the thinning process and the plurality of corresponding positions corresponding to the plurality of positions included in the correction surface, respectively.

FIG. 15A is a diagram for describing setting of a distance between the machined surface and the correction surface. The setter 119 sets distances between a plurality of positions of the machined surface and corresponding positions in the correction surface, which corresponds to the plurality of positions, respectively, based on, for example, an operation of the user on the input/output device 106.

The setter 119 sets, for example, a distance between a position P1 indicated by the machined surface data and the correction surface to 0.

The correction surface generator 118 generates the correction surface based on the distance set by the setter 119. Therefore, when the distance between the position P1 included in the machined surface data and the correction surface is set to 0, the correction surface generator 118 sets the distance between the position P1 included in the machined surface data and the correction surface to 0. In other words, the correction surface generator 118 does not correct the position P1 indicated by the machined surface data.

Furthermore, the setter 119 sets, for example, a distance between a position P4 included in the machined surface data and the correction surface to 0. In this case, the correction surface generator 118 does not correct the position P4.

Further, the setter 119 sets a distance between a position P2 included in the machined surface data and the correction surface to D1. The correction surface generator 118 generates a correction surface such that the distance between the position P2 included in the machined surface data and the correction surface is within D1.

Further, the setter 119 sets a distance between a position P3 included in the machined surface data and the correction surface to D2. The correction surface generator 118 generates a correction surface such that the distance between the position P3 included in the machined surface data and the correction surface is within D2.

FIG. 15B is an example of a correction surface generated by the correction surface generator 118. The correction surface generator 118 generates a correction surface without correcting the position P1 and the position P4.

Meanwhile, the correction surface generator 118 corrects the position P2 to a position P2A. A distance between the position P2A on the correction surface and the position P2 on the machined surface is equal to or less than D1.

Moreover, the correction surface generator 118 corrects the position P3 to a position P3A. A distance between the position P3A on the correction surface and the position P3 on the machined surface is equal to or less than D2.

The setter 119 may individually set the distances between the plurality of positions on the machined surface and the plurality of corresponding positions on the correction surface, respectively, based on a curvature of the machined surface indicated by the machined surface data.

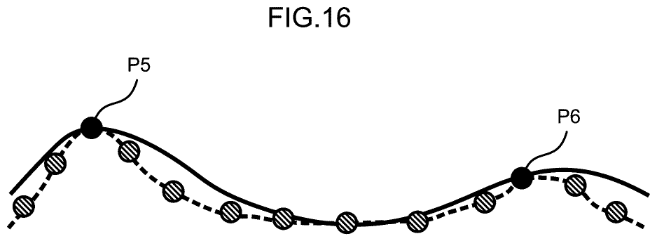

FIG. 16 is a diagram illustrating an example of the machined surface. A dotted line indicates the machined surface. A solid line indicates the correction surface. In the machined surface illustrated in FIG. 16, curvatures near a position P5 and near a position P6 are larger than curvatures at other positions.

For example, the setter 119 sets a distance between a position on the machined surface, the curvature of which is equal to or greater than a predetermined threshold value, and a corresponding position on the correction surface to 0. In addition, the setter 119 sets a distance between a position on the machined surface whose curvature is less than the predetermined threshold value and a corresponding position on the correction surface to a range equal to or less than a predetermined value.

When curvatures at the position P5 and the position P6 are equal to or greater than a predetermined threshold, the correction surface generator 118 does not correct the machined surface data at the position P5 and the position P6. In addition, when curvatures at positions other than the position P5 and the position P6 are less than the predetermined threshold, the correction surface generator 118 corrects the machined surface data so that correction amounts at the positions other than the position P5 and the position P6 become equal to or less than the predetermined value.

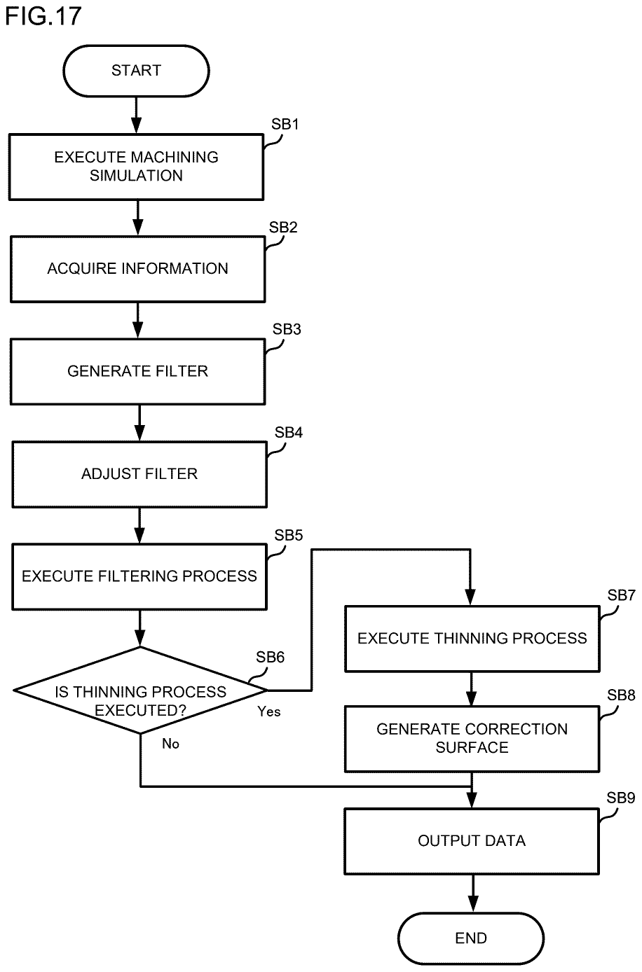

FIG. 17 is a flowchart illustrating an example of processing executed by the shape restoration device 1. In the processing illustrated in FIG. 17, processing from step SB1 to step SB5 is the same as processing from step SA1 to SA5 illustrated in FIG. 10. Therefore, description of the processing from step SB1 to step SB5 will be omitted.

When processing of step SB5 is completed, the thinning processor 117 determines whether or not to execute a thinning process of the machined surface data (step SB6). When the thinning processor 117 determines to execute the thinning process (Yes in step SB6), the thinning processor 117 executes the thinning process (step SB7).

Next, the correction surface generator 118 generates a correction surface obtained by correcting the machined surface from the machined surface data in which a piece of the data is thinned out (step SB8). Finally, the output 116 outputs correction surface data indicating the correction surface corrected by the correction surface generator 118 (step SB9), and the process ends.

On the other hand, when the thinning processor 117 determines not to execute the thinning process (No in step SB6), the output 116 outputs the new machined surface data generated by executing the filtering process (step SB9), and the process ends.

As described above, the shape restoration device 1 includes the acquirer 112 for acquiring the machining information indicating the condition when the machined surface is machined by the tool, the path information indicating the path when the machined surface is machined by the tool, and the machined surface data indicating the state of the machined surface, the filter generator 113 for generating the filter for extracting the shape component of the machined surface from the machined surface data based on the machining information acquired by the acquirer 112, the adjuster 114 for adjusting the direction of the filtering process using the filter on the machined surface data or adjusting the filter coefficients based on the path information, and the filter processor 115 for executing the filtering process based on the adjustment result by the adjuster 114.

Therefore, the shape restoration device 1 can extract the shape component from the machined surface data including cutting marks, etc. In other words, the shape restoration device 1 can acquire machined surface data indicating the design shape of the workpiece from the machined surface data including cutting marks, etc. For this reason, the shape restoration device 1 can acquire the machined surface data indicating the design shape of the workpiece even when there is no design data indicating the shape of the workpiece.

In addition, the shape restoration device 1 further includes the simulator 111 for executing machining simulation to generate machined surface data. Therefore, the shape restoration device 1 can restore the design shape of the machined surface MS using the machined surface data before the workpiece is actually machined.

The machined surface data may be inspection data acquired by the inspection device for inspecting the state of the machined surface MS. Therefore, the shape restoration device 1 can restore the design shape of the machined surface MS from the machined surface data of the machined surface MS which is actually machined.

In addition, the machining information includes at least one of information indicating the radius of the tool, information indicating a shape of the tool, information indicating the number of teeth of the tool, information indicating maximum acceleration of a control axis, information indicating an acceleration time of the control axis, information indicating a time constant of a servo mechanism, information indicating gain of the servo mechanism, information indicating a pick feed, or information indicating a point sequence distance. Therefore, the shape restoration device 1 can generate a filter based on various information.

In addition, the shape restoration device 1 further includes the thinning processor 117 for performing the thinning process to thin out some data from the machined surface data undergoing the filtering process, and the correction surface generator 118 for generating the correction surface obtained by correcting the machined surface from machined surface data obtained by thinning out some of the data by the thinning processor 117. In addition, the thinning processor 117 performs the thinning process using at least one of uniform sampling, random sampling, or normal space sampling.

Therefore, even when the machined surface undergoing the filtering process has a defect such as a streak or a pattern, the shape restoration device 1 can restore the shape of the machined surface.

In addition, the correction surface generator 118 generates the correction surface so that the difference between the machined surface MS undergoing the filtering process and the correction surface falls within a predetermined range. For this reason, the shape restoration device 1 can restore the shape of the machined surface.

In addition, the correction surface generator 118 generates a correction surface using at least one of a linear interpolation curved surface approximation, a cubic spline interpolation curved surface approximation, a nearest neighbor point interpolation curved surface approximation, or an interpolation approximation using a radial basis function. Therefore, the shape restoration device 1 can properly restore the shape of the machined surface.

In addition, the shape restoration device 1 further includes the setter 119 that individually sets the distances between the plurality of positions included in the machined surface data undergoing the thinning process and the plurality of corresponding positions corresponding to the plurality of positions included in the correction surface, respectively. The correction surface generator 118 generates the correction surface based on the distance set by the setter 119. Therefore, the user can set how to correct the machined surface.

In addition, the setter 119 individually sets distances between a plurality of positions and a plurality of corresponding positions, respectively, based on the curvature of the machined surface indicated by the machined surface data. For example, the setter 119 can perform setting not to correct the machined surface data in a part having a large curvature. In this case, the shape restoration device 1 can leave a shape of a corner and a boundary between surfaces indicated by the shape component on the correction surface generated by the correction surface generator 118 without change.

Even though the disclosure is described in detail, the disclosure is not limited to the above-mentioned individual embodiments. Various additions, substitutions, modifications, partial deletions, etc. are possible in these embodiments without departing from the gist of the disclosure, or without departing from the gist of the disclosure derived from content described in the claims and equivalents thereto. In addition, these embodiments can be implemented in combination.

Supplementary notes on the embodiments of the present disclosure will be presented below.
Supplementary Note [1]

A shape restoration device including: an acquirer configured to acquire machining information indicating a condition when a machined surface is machined by a tool, path information indicating a path when the machined surface is machined by the tool, and machined surface data indicating a state of the machined surface; a filter generator configured to generate a filter for extracting a shape component of the machined surface from the machined surface data based on the machining information acquired by the acquirer; an adjuster configured to perform, based on the path information, an adjustment of a direction of a filtering process using the filter on the machined surface data or an adjustment of coefficients of the filter; and a filter processor configured to execute the filtering process based on an adjustment result by the adjuster.
Supplementary Note [2]

The shape restoration device according to Supplementary Note [1], further including a simulator configured to generate the machined surface data by executing a machining simulation.
Supplementary Note [3]

The shape restoration device according to Supplementary Note [1], wherein the machined surface data is inspection data acquired by an inspection device configured to inspect a state of the machined surface.
Supplementary Note [4]

The shape restoration device according to any one of Supplementary Notes [1] to [3], wherein the machining information includes at least one of information indicating a radius of the tool, information indicating a shape of the tool, information indicating a number of teeth of the tool, information indicating maximum acceleration of a control axis, information indicating an acceleration time of the control axis, information indicating a time constant of a servo mechanism, information indicating gain of the servo mechanism, information indicating a pick feed, or information indicating a point sequence distance.
Supplementary Note [5]

The shape restoration device according to any one of Supplementary Notes [1] to [4], further including: a thinning processor configured to execute a thinning process to thin out some data from the machined surface data undergoing the filtering process; and a correction surface generator configured to generate a correction surface obtained by correcting the machined surface from the machined surface data that a piece of the data is thinned out by the thinning processor.
Supplementary Note [6]

The shape restoration device according to Supplementary Note [5], wherein the thinning processor executes the thinning process using at least one of uniform sampling, random sampling, or normal space sampling.
Supplementary Note [7]

The shape restoration device according to Supplementary Note [5] or [6], wherein the correction surface generator generates the correction surface so that a difference between the machined surface undergoing the filtering process and the correction surface falls within a predetermined range.
Supplementary Note [8]

The shape restoration device according to any one of Supplementary Notes [5] to [7], wherein the correction surface generator generates the correction surface using at least one of a linear interpolation curved surface approximation, a cubic spline interpolation curved surface approximation, a nearest neighbor point interpolation curved surface approximation, or an interpolation approximation using a radial basis function.
Supplementary Note [9]

The shape restoration device according to any one of Supplementary Notes [5] to [8], further including a setter configured to individually set distances between a plurality of positions included in the machined surface data undergoing the thinning process and a plurality of corresponding positions corresponding to a plurality of positions included in the correction surface, respectively, wherein the correction surface generator generates the correction surface based on the distance set by the setter.
Supplementary Note [10]

The shape restoration device according to Supplementary Note [9], wherein the setter individually sets the distances between the plurality of positions and the plurality of corresponding positions based on a curvature of the machined surface indicated by the machined surface data.
Supplementary Note [11]

A computer-readable storage medium storing an instruction for causing a computer to: acquire machining information indicating a condition when a machined surface is machined by a tool, path information indicating a path when the machined surface is machined by the tool, and machined surface data indicating a state of the machined surface; generate a filter for extracting a shape component of the machined surface from the machined surface data based on the acquired machining information; execute adjustment of a direction of a filtering process using the filter on the machined surface data or adjustment of coefficients of the filter based on the path information; and execute the filtering process based on an adjustment result.

1. A shape restoration device comprising:
an acquirer configured to acquire machining information indicating a condition when a machined surface is machined by a tool, path information indicating a path when the machined surface is machined by the tool, and machined surface data indicating a state of the machined surface;
a filter generator configured to generate a filter for extracting a shape component of the machined surface from the machined surface data based on the machining information acquired by the acquirer;
an adjuster configured to perform, based on the path information, an adjustment of a direction of a filtering process using the filter on the machined surface data or an adjustment of coefficients of the filter; and
a filter processor configured to execute the filtering process based on an adjustment result by the adjuster.

2. The shape restoration device according to claim 1, further comprising a simulator configured to generate the machined surface data by executing a machining simulation.

3. The shape restoration device according to claim 1, wherein the machined surface data is inspection data acquired by an inspection device configured to inspect a state of the machined surface.

4. The shape restoration device according to claim 1, wherein the machining information includes at least one of information indicating a radius of the tool, information indicating a shape of the tool, information indicating a number of teeth of the tool, information indicating maximum acceleration of a control axis, information indicating an acceleration time of the control axis, information indicating a time constant of a servo mechanism, information indicating gain of the servo mechanism, information indicating a pick feed, or information indicating a point sequence distance.

5. The shape restoration device according to claim 1, further comprising:
a thinning processor configured to execute a thinning process to thin out some data from the machined surface data undergoing the filtering process; and
a correction surface generator configured to generate a correction surface obtained by correcting the machined surface from the machined surface data that a piece of the data is thinned out by the thinning processor.

6. The shape restoration device according to claim 5, wherein the thinning processor executes the thinning process using at least one of uniform sampling, random sampling, or normal space sampling.

7. The shape restoration device according to claim 5, wherein the correction surface generator generates the correction surface so that a difference between the machined surface undergoing the filtering process and the correction surface falls within a predetermined range.

8. The shape restoration device according to claim 5, wherein the correction surface generator generates the correction surface using at least one of a linear interpolation curved surface approximation, a cubic spline interpolation curved surface approximation, a nearest neighbor point interpolation curved surface approximation, or an interpolation approximation using a radial basis function.

9. The shape restoration device according to claim 5, further comprising a setter configured to individually set distances between a plurality of positions included in the machined surface data undergoing the thinning process and a plurality of corresponding positions corresponding to a plurality of positions included in the correction surface, respectively,
wherein the correction surface generator generates the correction surface based on the distance set by the setter.

10. The shape restoration device according to claim 9, wherein the setter individually sets the distances between the plurality of positions and the plurality of corresponding positions based on a curvature of the machined surface indicated by the machined surface data.

11. A computer-readable storage medium storing an instruction for causing a computer to:
acquire machining information indicating a condition when a machined surface is machined by a tool, path information indicating a path when the machined surface is machined by the tool, and machined surface data indicating a state of the machined surface;
generate a filter for extracting a shape component of the machined surface from the machined surface data based on the acquired machining information;
execute adjustment of a direction of a filtering process using the filter on the machined surface data or adjustment of coefficients of the filter based on the path information; and
execute the filtering process based on an adjustment result.
